(19) United States
(12) Patent Application Publication
(10) Pub. No.: US 2016/0036287 A1
(43) Pub. Date: Feb. 4, 2016

(54) Window Regulator Drive Unit

(71) Applicant: HI-LEX CONTROLS, INC., Rochester Hills, MI (US)

(72) Inventors: Charles L. Hazel, Wolverine Lake, MI (US); John M. Heiberger, Grand Blanc, MI (US)

(73) Assignee: HI-LEX CONTROLS, INC.

(21) Appl. No.: 14/448,304

(22) Filed: Jul. 31, 2014

(51) Int. Cl. H02K 5/22; H02K 15/00; H02K 7/116

(52) U.S. Cl. CPC H02K 5/22; H02K 7/1166; H02K 15/00

(57) ABSTRACT

A drive unit for a window regulator assembly incorporating improved component assembly features. The drive unit motor assembly is provided with motor locating features, and a housing is provided with attachment features. The motor locating an attachment features have snap-fit attachment. The assembly provides an assembly process in which a splined stub shaft of the motor assembly may be aligned with an internal splined bore of a drum gear as the motor assembly and housing are fastened together. The motor locating feature snap fits with the attachment features in a final assembled condition.

### FIELD OF THE INVENTION

This invention relates to an automotive body component and particularly to a window regulator drive unit incorporating snap-fit attachment features between a motor assembly and housing.

### BACKGROUND

Modern motor vehicles incorporate complex structures and mechanisms for providing safety, performance, and utility. Original Equipment Manufacturers (OEM) and component suppliers for OEMs continuously seek to improve the design of automotive components to enhance their function, reliability, longevity, reduce warranty costs, and simplify component assembly. Typical passenger cars incorporate remotely controlled movable door glass which is moved between upper and lower positions using window regulator mechanisms. Such mechanisms may be manually operated but are more typically powered by an electric motor controlled via switches usually found on a door trim panel. Many window regulator mechanisms designs are known. One design type uses a drive unit having a cable driven by an electric motor through a cable drum. These types frequently incorporate a motor assembly which includes a gear housing formed of molded plastic which must be assembled and connected to a drum gear and a drum housing, which drive unit is in turn mounted to a door inner panel. The motor assembly and housing are conventionally attached to one another using screw type or other discrete fasteners. Typically, a number of fasteners are used for this attachment such as screws along with associated nuts, and in order to provide sufficient integrity of the connection, steel insert molded collars are often also used, together resulting in numerous discrete components. In view of the desire to improve the production process for automotive components there is a need for such a drive unit incorporating rapid quality assembly of these components which does not require the use of threaded or other discrete fasteners which generally are labor-intensive and involve a high part count.

A window regulator drive unit is provided in accordance with the present invention which provides enhanced motor to housing assembly features. Two drive unit embodiments are described each enabling rapid and high quality assembly of these components, while eliminating or reducing the required number of threaded fasteners and related components.

### BRIEF DESCRIPTION OF THE DRAWINGS

FIG. 1 is a pictorial view of a window regulator drive unit in accordance with a first embodiment of the present invention;

FIG. 2 is an exploded pictorial view of the window regulator assembly drive unit shown in FIG. 1;

FIG. 3 is a cross-sectional view taken along line 3-3 from FIG. 1 showing a motor attachment feature;

FIG. 4 is a cross-sectional view taken along line 4-4 from FIG. 1;

FIG. 5 is a pictorial view of a window regulator assembly drive unit in accordance with a second embodiment of the present invention;

FIG. 6 is an exploded pictorial view of the drive unit shown in FIG. 5;

FIG. 7 is an enlarged cutaway pictorial view showing a motor attachment feature of the embodiment of FIG. 5; and

FIG. 8 is a cross-sectional view taken along line 8-8 from FIG. 7.

### DETAILED DESCRIPTION OF THE INVENTION

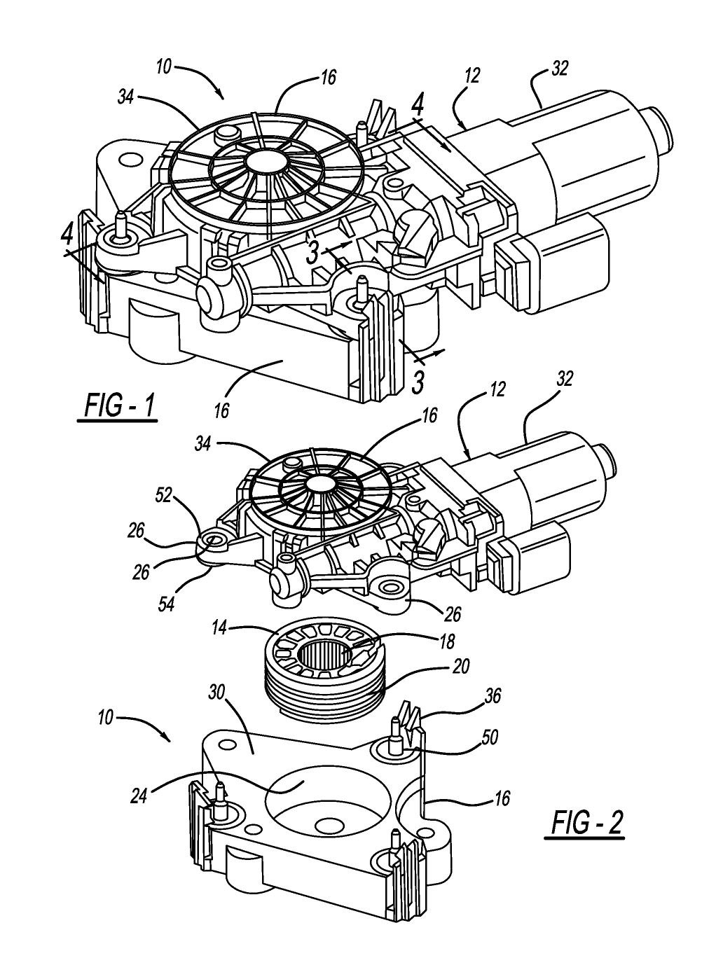

In accordance with this invention two embodiments of window regulator drive units having enhanced motor to housing assembly features are described. Referring particularly to FIGS. 1 through 4, a first embodiment of such a drive unit is shown which is generally designated by reference number 10. Drive unit assembly 10 is intended to be mounted to an inner door panel of a motor vehicle in accordance with prior art designs. Drive unit 10 drives a cable coupled to a carrier component fastened to a door glass panel for moving the panel between open and closed positions. These features are well known in accordance with the prior art.

Drive unit 10 incorporates three principal components illustrated in FIG. 2; namely, motor assembly 12, drum gear 14, and housing 16. These three components are shown in FIG. 2 in an exploded condition, and fully assembled in FIG. 1.

Drum gear 14 forms splined inner bore 18 with an outer grooved cylindrical surface defining a cable pulley 20 for guiding and supporting a window regulator drive cable (not shown). Drum gear 14 further incorporates an internal feature for a fixing a segment or multiple segments of the drive cable (not shown). As best shown in FIG. 4, a downward projecting splined stub shaft 22 projects from motor assembly 12 which interengage with splined bore 18 when the components are assembled. During a typical assembly process, drum gear 14 having associated regulator cables wound on cable pulley 20 is first placed within central cavity 24 of housing 16. Thereafter, motor assembly 12 is attached rigidly to housing 16.

Motor assembly 12 includes electric motor 32 which is fastened to molded gear housing 34, having internal components not illustrated in the drawings including a worm gear driven by a motor shaft and a ring gear enclosed by the dome-shaped and ribbed portion of gear housing 34. Stub shaft 22 is driven by the internal ring gear. Motor assembly 12 can be sourced as the subassembly illustrated.

As previously mentioned, the assembly of motor assembly 12 to housing 16 is normally accomplished using one or more discrete fasteners such as threaded fasteners which are threaded into associated bores formed in housing 16. In accordance with a first embodiment of the present invention, motor assembly 12 integrally incorporates three extending motor locating features 26 in the form of the ears with internal bores 28. In prior art designs, bores 28 could be used to receive a threaded fastener. In accordance with this invention however, other attachment features are provided which engage with locating features 26. Housing motor locating features 26 feature a pair of parallel upper and lower circular surfaces 52 and 54, respectively.

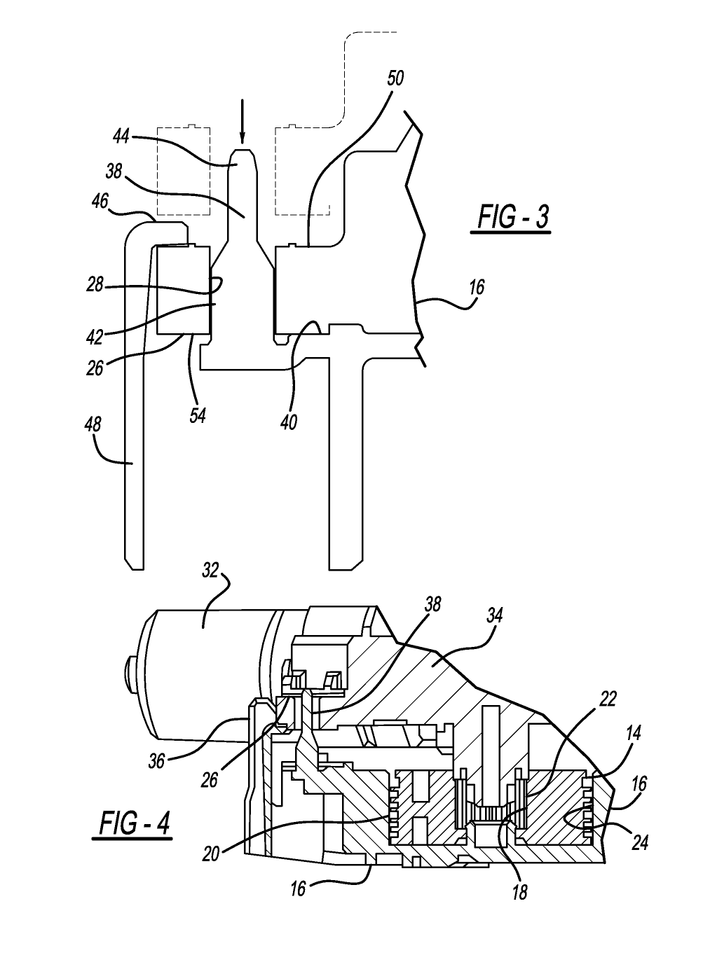

With particular reference to FIG. 2 and housing 16, it is shown that the housing forms the central cavity 24 described previously to receive drum gear 14. Housing 16 further forms mounting surface 30 which mate with corresponding surfaces of motor assembly 12 when these components are assembled. Housing 16 further forms three attachment features 36 shown in section with reference to FIG. 3, which are discussed in more detail as follows.

Attachment features 36 of housing 16 incorporate a central tapered pin 38 extending upwardly from mounting surface 40. Tapered pin 38 defines an enlarged diameter cylindrical section 42 having an outside diameter which is closely received by bore 28. Tapered pin 38 further features an upwardly extending reduced diameter terminal end section 44. Attachment features 36 further incorporate snap-fit housing fingers 48 which extend from housing 16 in a cantilever manner and have an upper flange 46. Attachment features 36 further include formed locating surface 50 which meets with corresponding features of gear housing 34. In one embodiment, locating features 50 are in the form of semicircular ridges as shown in FIG. 2.

With reference to FIGS. 1 through 4, an assembly process for a first embodiment of drive unit 10 is described. Drum gear 14 is first installed within housing cavity 24, shown by FIG. 4. Typically drum gear 14 would have been wound with cable (not shown). Next, motor assembly 12 is oriented such that stub shaft 22 is aligned with drum splined bore 18. In addition, motor locating feature bores 28 are positioned over tapered pins 38. In an initial position, gear housing 34 is positioned such that pin terminal end sections 44 are received within bores 28. Since terminal end sections 44 have a significantly smaller diameter than the inside diameter of bores 28, a slight amount of angular rotation of gear housing 34 relative to housing 16 is permitted. This is desirable to allow stub shaft 22 to engage with drum gear splined bore 18 as the spline features mate. When assembling together mating splined shafts and bores, it is typically necessary to permit a small degree of relative angular rotation between the components to allow the mating spline profiles to engage one another. In the partially assembled condition, motor locating feature 26 is able to rest on the upper surface of flange 46. Once the registration and meshing of stub shaft 22 into splined bore 18 occurs, motor assembly 12 may be forcibly pushed downwardly against housing 16 which causes outward deflection of fingers 48 until the components reach the position illustrated in full lines in FIG. 3. In that position, the lower surface 54 of motor locating feature 26 is mates with locating surface 50 and tapered pin cylindrical section 42 is closely received by motor locating feature bore 28. This provides the desired highly accurate relative positioning of the components once in the final assembled condition.

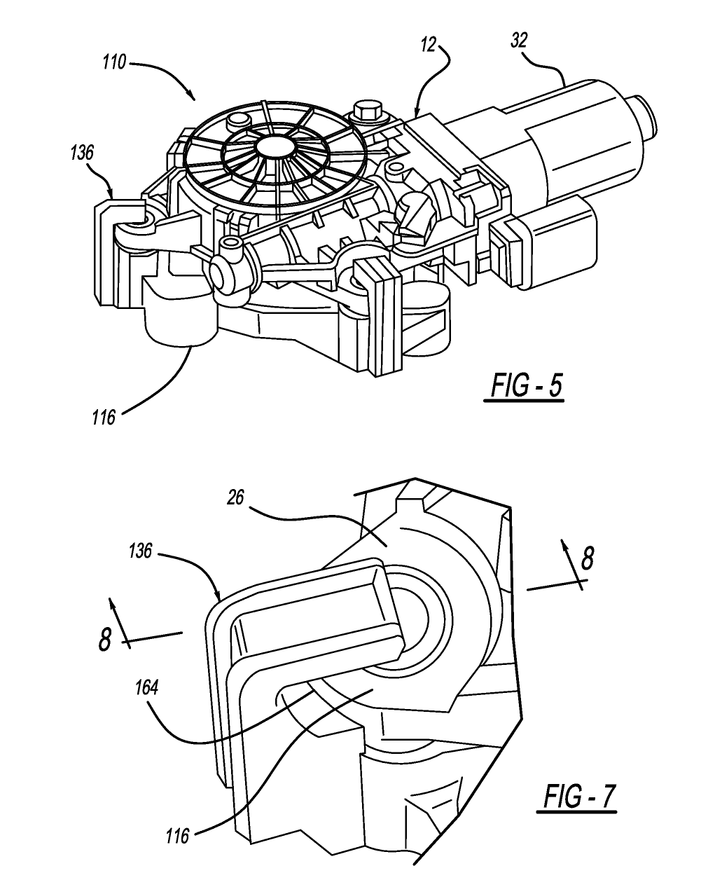

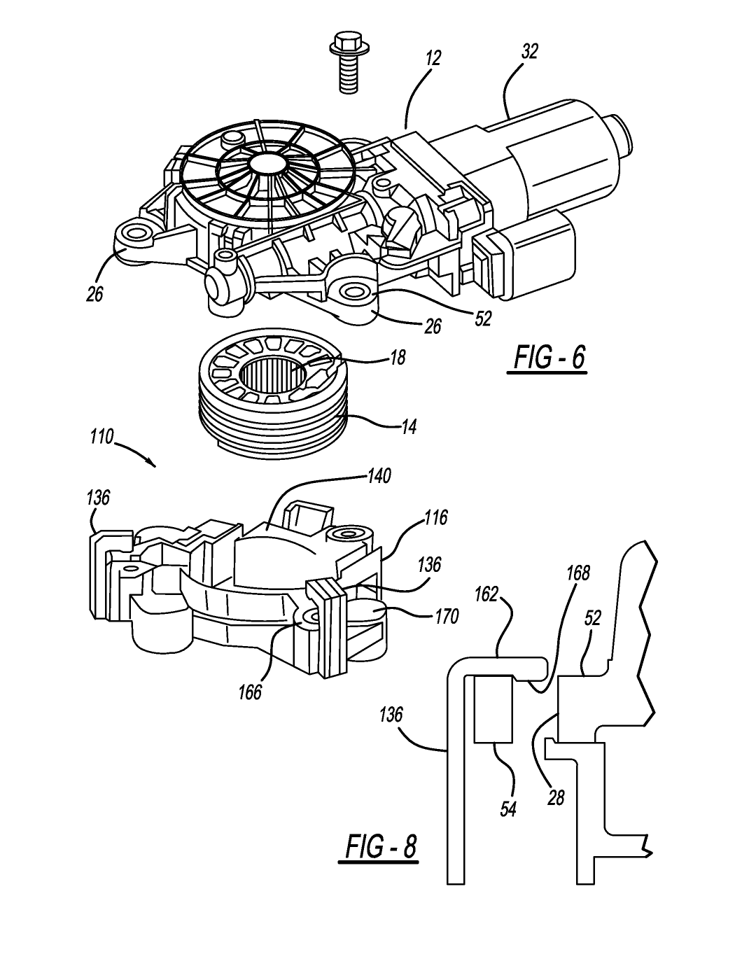

Now with reference to FIGS. 5 through 8, a second embodiment of drive unit 110 is provided. Components which are identical to those described in connection with drive unit 10 described previously are identified with like reference numbers. Components corresponding to components previously described but having a different configuration for the second embodiment are identify with like reference numbers with 100 added. For this embodiment, motor assembly 12 along with motor locating features 26 is identical to the first embodiment. The primary difference of this embodiment is related to the configuration of housing 116 and in particular, attachment features 136 have a different configuration. For this embodiment retention features 136 include upstanding flange 162 intended to trap motor locating features 26 against mounting surface 140. Attachment feature 136 is configured to allow motor locating feature 26 to slide into final position when motor assembly and housing 116 a rotated from one to another clock position. For this purpose, attachment feature 136 provides an assembly opening 164 with the opposite direction being blocked by wall 166. Upstanding flange 136 features a downwardly projecting posts section 168 which is configured to fit into motor locating feature bore 28 when the parts are in their final assembled condition. To provide a rest for motor assembly 12 in a pre-assembled condition housing when 138 is provided.

As in the first embodiment, assembly begins with drum gear 14 installed within housing 116. Next motor assembly 12 is dropped against housing 116 at a position in which locating features 26 and attachment features 136 are not aligned, rather motor assembly 12 is indexed rotationally to the final assembled position. Motor locating features 26 may be resting against housing tab 170 as motor assembly 12 is pressed against mounting surface 140 as parts are rotated relative to one another until motor locating features 26 enter assembly opening 164 and the parts reach their final position at which point post section 168 snaps into bore 28. The components are dimensioned as such that some deflection of flange 136 occurs until the parts reach their final position at which point these components return to their unstressed state. Motor locating feature 126 positively locates the components.

In both embodiments a snap-fit assembly feature is provided as components are resiliently deflected while the assembly of the motor assembly 12 and housing 16 and 116 occurs. It should be noted that in the description of the embodiments of drive unit 10 and 110, three of the motor locating features 26 and related attachment features 36 are described. Embodiments of the present invention may be provided with a greater or less number of such features. Moreover, the features may be replaced in some instances with conventional types of fasteners such as threaded fasteners, rivets or other discrete fasteners. While such embodiments do not entirely avoid the use of such fasteners, they do promote rapid assembly and reduce part count.

While the above description constitutes the preferred embodiment of the present invention, it will be appreciated that the invention is susceptible to modification, variation, and change without departing from the proper scope and fair meaning of the accompanying claims.

1. A drive unit for a window regulator assembly for a motor vehicle comprising;
a motor assembly including a gear housing with at least one motor locating feature, an upper locating surface, and a lower locating surface, the motor assembly further having a splined stub shaft,
a drum gear having an inner splined bore and an outer cable pulley surface, and
a housing forming an internal cavity for receiving the drum gear, the housing defining at least one attachment feature for locating and fastening with the motor locating feature, the attachment feature having a finger with a flange portion and a motor locating surface, the attachment features permitting relative rotation between the motor assembly and the drum thereafter receiving and mounting the motor locating feature.

2. The drive unit of claim 1 further comprising wherein the motor assembly defines three of the motor locating features and the housing forms three of the attachment features adapted to mate with a corresponding one of the motor locating features.

3. The drive unit of claim 1 further comprising wherein the attachment feature includes a projecting pin having a first diameter section closely conforming with a motor locating feature bore and further including an upwardly projecting reduced diameter section, wherein in an initial assembled condition, the motor assembly is placed in an intermediate position in which the reduced diameter pin portion enters the bore while the motor locating feature rests upon the flange, the intermediate position permitting relative motion between the motor assembly and the drum gear allowing the splined stub shaft to engage with the drum splined bore, in a final assembled condition the motor assembly is pressed against the housing such that the motor locating feature deflects the finger and the finger flange engages the upper motor locating feature and the lower surface engages the housing mounting surface.

4. The drive unit of claim 3 further comprising the housing further forming a cylindrical section for mating with the motor locating feature.

5. The drive unit of claim 1 further comprising the attachment feature having a flange and defining a side facing assembly opening enabling the motor assembly to be placed in engagement with the housing as the splined stub shaft engages with the drum gear splined bore, and upon relative rotation of the motor assembly and the housing the motor locating features are engaged by the attachment features and the retention feature forms a projection which engages with the bores.

6. The drive unit of claim 1 further comprising wherein the attachment features are provided integrally by the housing.

7. The drive unit of claim 1 further comprising wherein the motor locating features are formed integrally with the gear housing of the motor assembly.

8. A drive unit for a window regulator assembly for a motor vehicle comprising;
a motor assembly including a gear housing with at least one motor locating feature having an upper locating surface, and a lower locating surface, the motor assembly further having a splined stub shaft,
a drum gear having an inner splined bore and an outer cable pulley surface, and
a housing forming an internal cavity for receiving the drum gear, the housing defining at least one attachment feature for locating and fastening with the motor locating feature, the attachment feature having a finger with a flange portion and a motor locating surface, the attachment features permitting relative rotation between the motor assembly and the drum thereafter receiving and mounting the motor locating feature, wherein the attachment feature includes a projecting pin having a first diameter section closely conforming with a motor locating feature bore and further including an upwardly projecting reduced diameter section, wherein in an initial assembled condition, the motor assembly is placed in an intermediate position in which the reduced diameter pin portion enters the bore while the motor locating feature rests upon the flange, the intermediate position permitting relative motion between the motor assembly and the drum gear allowing the splined stub shaft to engage with the drum splined bore, and in a final assembled condition, the motor assembly is pressed against the housing such that the motor locating feature deflects the finger and the finger flange engages the upper motor locating feature and the lower surface engages the housing mounting surface.

9. A drive unit for a window regulator assembly for a motor vehicle comprising;
a motor assembly including a gear housing with at least one motor locating feature, an upper locating surface, and a lower locating surface, the motor assembly further having a splined stub shaft,
a drum gear having an inner splined bore and an outer cable pulley surface, and
a housing forming an internal cavity for receiving the drum gear, the housing defining at least one attachment feature for locating and fastening with the motor locating feature, the attachment feature having a finger with a flange portion and a motor locating surface, the attachment features permitting relative rotation between the motor assembly and the drum thereafter receiving and mounting the motor locating feature, the attachment feature having a flange and defining a side facing assembly opening enabling the motor assembly to be placed in engagement with the housing as the splined stub shaft engages with the drum gear splined bore, and upon relative rotation of the motor assembly and the housing the motor locating features are engaged by the attachment features and the retention feature forms a projection which engages with the bores.

10. A method of assembling a drive unit of a window regulator assembly comprising the steps of;
providing a motor assembly including a gear housing with at least one motor locating feature forming a bore, an upper locating surface, and a lower locating surface, the motor assembly further having a splined stub shaft,
providing a drum gear having an inner splined bore and an outer cable pulley surface,
providing a housing forming an internal cavity for receiving the drum gear, the housing defining at least one attachment feature for locating and fastening with the motor locating feature, the attachment feature having a finger with a flange portion and a motor locating surface, the attachment features permitting relative rotation between the motor assembly and the drum here and thereafter receiving and mounting the motor locating feature,
placing the drum gear into the central cavity of the housing, positioning the motor assembly relative to the housing in an initial assembled condition in which the splined stub shaft and the splined bore our aligned, and
pressing the motor assembly and the housing together such that the motor locating features and the attachment features are engaged.
